(19) United States
(12) Patent Application Publication
(10) Pub. No.: US 2024/0375216 A1
(43) Pub. Date: Nov. 14, 2024

(54) Laser Welding Method, Fuel Cell, and Computer Readable Medium

(71) Applicant: Robert Bosch GmbH, Stuttgart (DE)

(72) Inventors: Wei Zhang, Suzhou (CN); Guixiang Xiao, Suzhou (CN); Jiangping Li, Suzhou (CN); Shulong Fang, Suzhou (CN); Yanrui Kuang, Suzhou (CN); Yunfei Che, Suzhou (CN)

(21) Appl. No.: 18/655,407

(22) Filed: May 6, 2024

(30) Foreign Application Priority Data
May 11, 2023 (CN) 2023 1053 1763.8

(51) Int. Cl. B23K 26/08

(52) U.S. Cl. CPC B23K 26/0892

(57) ABSTRACT

A laser welding method, a fuel cell, and a computer readable medium are disclosed. The laser welding method includes (i) securing the bipolar plate in place and fitting an area to be welded of the bipolar plate, (ii) determining a predetermined trajectory on the area to be welded for an alignment point of a laser welding device, the predetermined trajectory including a starting point and an end point, (iii) moving the alignment point of the laser welding device along the predetermined trajectory from the starting point and activating a laser emitter of the laser welding device, and (iv) turning off the laser emitter prior to the end point of the predetermined trajectory and keeping the alignment point moving along the predetermined trajectory until the end point of the predetermined trajectory is reached. The method and the device according to this disclosure effectively avoid a perforation defect in bipolar plate welding.

This application claims priority under 35 U.S.C. § 119 to patent application no. CN 2023 1053 1763.8, filed on May 11, 2023 in China, the disclosure of which is incorporated herein by reference in its entirety.

The present disclosure relates to the field of fuel cells, and more particularly, relates to a bipolar plate welding method in a fuel cell.

### BACKGROUND

A fuel cell generally includes a plurality of battery cells, each including a bipolar plate between a membrane electrode and a membrane electrode. The bipolar plate divides the space between adjacent membrane electrode assemblies into an anodic fluid channel, a cathodic fluid channel, and a cooling fluid channel.

In general, the bipolar plate is formed by the welding of a positive plate and a negative plate, and welds include peripheral welds along the perimeter of the positive and negative plates and a central weld of a central active region of the positive and negative plates. A groove position is typically provided between the flow channels of the bipolar plate, and laser welding is generally employed due to the narrower width of the groove and the thinner bipolar plate itself. However, at an end position of the weld, due to the energy concentration, the bipolar plate may be burned and perforated, which will result in a leak between the various fluid channels separated by the bipolar plate.

In order to avoid this defect, the prior art proposes a method of step-by-step increasing laser power at the starting point of the weld and gradually decreasing laser power before the end point. However, this approach is not feasible for short-range welds as it may result in incomplete fusion and insufficient weld strength.

### SUMMARY

An object of the present application is to solve or at least alleviate problems existing in the prior art.

In an aspect, a laser welding method for a bipolar plate of a hydrogen fuel cell is provided, comprising:
securing the bipolar plate in place and fitting an area to be welded of the bipolar plate;
determining a predetermined trajectory on the area to be welded for an alignment point of a laser welding device, the predetermined trajectory including a starting point and an end point;
moving the alignment point of the laser welding device along the predetermined trajectory from the starting point and activating a laser emitter of the laser welding device; and
turning off the laser emitter prior to the end point of the predetermined trajectory and maintaining movement of the alignment point along the predetermined trajectory until the end point of the predetermined trajectory is reached.

A fuel cell is further provided, wherein a bipolar plate of the fuel cell is soldered through the method according to an embodiment of the present disclosure.

A computer readable medium having a computer program recorded thereon is further provided, wherein, when the computer program is read and executed by a processor of the laser welding device, the processor causes the laser welding device to perform the method according to an embodiment of the present disclosure.

Methods and devices according to embodiments of the present disclosure are effective to avoid a perforated defect in bipolar plate welding.

### BRIEF DESCRIPTION OF THE DRAWINGS

With reference to the drawings, the content disclosed in the present application is to become understandable more easily. It will be readily understood by those skilled in the art that these drawings are for purposes of illustration only and are not intended to limit the scope of protection of the present application. Additionally, similar numerals in the figures are used to represent similar components, wherein:

FIG. 1 shows a schematic diagram of a single pole plate that designates an area to be welded;

FIG. 2 shows a cross-sectional schematic view of a bipolar plate and a membrane electrode when assembled;

FIG. 3 shows a cross-sectional schematic view of a bipolar plate during laser welding;

FIG. 4 shows a schematic diagram of a welding area and a predetermined trajectory according to one embodiment;

FIGS. 5 and 6 illustrate laser emitter power profiles according to different embodiments;

FIGS. 7 to 9 show schematic views of predetermined trajectories according to different embodiments; and

FIGS. 10 to 13 show an actual weld comparison of conventional welding methods and welding methods according to embodiments of the present disclosure.

### DETAILED DESCRIPTION

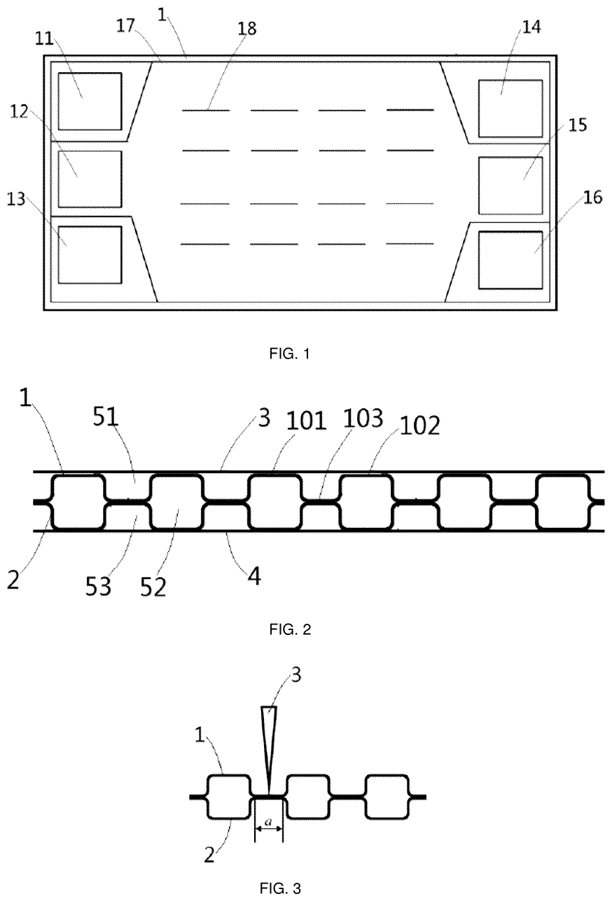

Referring first to FIG. 1, a single pole plate is shown that designates an area to be welded. The single polar plate 1 may be a cathodic plate or an anodic plate that includes a sealing region at both ends and an activation region in the middle. The polar plate includes ports 11,12,13,14,15,16 of the sealing regions at both ends, and these ports are used for the entry and exit of hydrogen, oxygen, and cooling water, respectively.

As shown in FIGS. 2 and 3, in the activation region, the polar plate includes a castellation to define a plurality of microchannels extending in a length direction thereof (left-right direction in FIG. 1). More specifically, as shown in FIG. 2, the anodic plate 1 includes protrusions 101, 102 and a groove 103 between adjacent protrusions 101, 102. Bipolar plates 1 and 2 need to be connected to each other prior to assembly with membrane electrodes 3 and 4. To ensure proper connection of the bipolar plates 1, 2, the bipolar plates 1, 2 are connected by a weld 17 along the perimeter and a weld 18 in the activation region. With further reference to FIG. 2, an anodic fluid channel 51 is defined between the anodic plate 1 and the first membrane electrode 3, a cathodic fluid channel 53 is defined between the cathodic plate 2 and the second membrane electrode 4, and a cooling fluid channel 52 is defined between the first pole plate 1 and the second pole plate 2. As shown in FIG. 3, the groove positions of the anodic plate 1 and the cathodic plate 2 are located in close proximity, while the weld 18 in the activation region is achieved primarily by allowing a laser beam 3 to perform laser welding along the grooves of the anodic plate 1 and the cathodic plate 2 with a width a of the groove of less than 0.5 mm, e.g., about 0.3 mm, and a thickness of the cathodic plate and the anodic plate of less than 0.1 mm, e.g., 0.075 mm. When a heat concentration occurs at the end point of the weld, the bipolar plate is perforated, which will cause a leak between the anodic fluid channel 51 and the cathodic fluid channel 53.

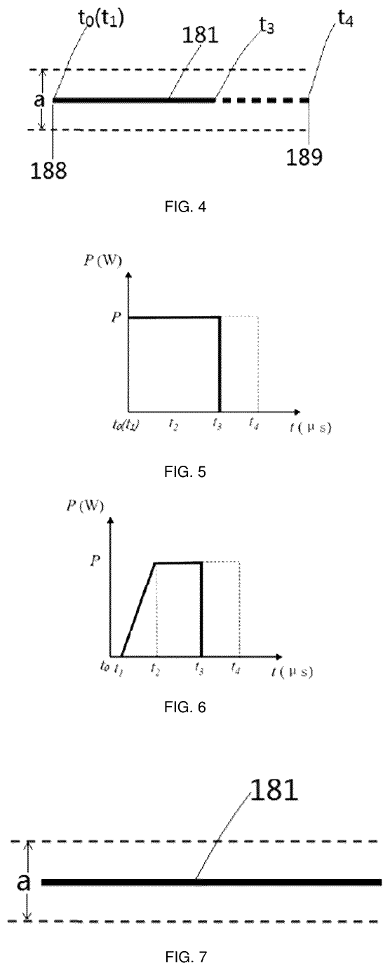

The laser welding method for a bipolar plate of a hydrogen fuel cell according to an embodiment of the present disclosure will be described with further reference to FIG. 4. The method comprises: securing the bipolar plate in place and fitting an area to be welded of the bipolar plate, i.e., the grooves between the flow channels; determining a predetermined trajectory on the area to be welded for an alignment point of the laser welding device, the predetermined trajectory including a starting point and an end point, taking as an example the predetermined trajectory 181 shown in FIG. 4, with a starting point 188 and an end point 189; moving the alignment point of the laser welding device along the predetermined trajectory 181 from the starting point 188 and activating the laser emitter of the laser welding device; and turning off the laser emitter prior to the end point 189 of the predetermined trajectory and maintaining movement of the alignment point along the predetermined trajectory until the end point 189 of the predetermined trajectory is reached. According to the method of the present disclosure, the laser emitter is turned off before the end point 189 of the predetermined trajectory of the alignment point and, in the view of FIG. 4, the turning-off point of the laser emitter is, for example, a t₃ point. In other words, the method according to the present disclosure teaches to still move the alignment point for a certain distance or time after the laser emitter is turned off, by which the inventors find that the thermal concentration and the resulting problems of welding perforations can be effectively avoided and the strength of welding between bipolar plates can be guaranteed.

With further reference to FIG. 5, a laser emitter power profile is shown. In the embodiment shown in FIG. 5, the laser emitter is activated at a first power P and the first power P is maintained until the laser emitter is turned off at the t₃ time point, while t₄ indicates that the alignment point ceases to move, i.e. the end point 189 of the predetermined trajectory in FIG. 4. Further, in this embodiment, the laser emitter is activated when the alignment point is at the starting point of the predetermined trajectory, i.e., the time point to at which the alignment point begins movement is the same point in time as the activated time point ti of the laser emitter. An alternative embodiment of a laser emitter power profile is described with further reference to FIG. 6. In this alternative embodiment, the laser emitter is activated at the lowest power at the ti time point and gradually increases to the first power P (t₂ time point), and the first power is maintained until the laser emitter is turned off (t₃ time point). In this embodiment, the laser emitter is activated after a first delay time at which the alignment point exits the starting point of the predetermined trajectory, i.e., there is an interval of the first delay time between the time point to at which the alignment point begins movement and the time point ti at which the laser transmitter is activated. In some embodiments, the time point t₃ at which the laser emitter is turned off may be associated with the end point of the predetermined trajectory, e.g., the laser emitter is turned off before a predetermined time or a predetermined distance from the alignment point to the end point 189 of the predetermined trajectory. For example, with a total weld length 4 mm, a weld speed 1000 mm/s, and a total weld time 4 ms (ti to t₃), the predetermined time is greater than 0.5 ms, and the predetermined distance is greater than 0.5 mm. In some embodiments, the predetermined distance is greater than 1/10 of the total weld length, and the predetermined time is greater than 1/10 of the total weld time. In some embodiments, the predetermined time is greater than 0.5 ms and the predetermined distance is greater than 0.5 mm. For actual operation, the weld length is pre-designed, then the predetermined trajectory is determined based on the required weld length. Multiple factors may be considered for the time point t₃ at which the laser emitter is turned off and the time point t₄ of the end point of the predetermined trajectory, and these may also be determined by experiments or judged based on experiences.

In some embodiments, the laser welding device includes a laser emitter and a galvanometric mirror, while the alignment point of the laser welding device is adjusted by the movement of the galvanometric mirror. Accordingly, the movement of the alignment point along the predetermined trajectory is achieved by the movement of the galvanometric mirror of the laser welding device and after the laser emitter is turned off at the t₃ time point, the galvanometric mirror is caused to continue to move until time t₄, at which the galvanometric mirror is stopped to move. In some embodiments, the movement of the galvanometric mirror is controlled such that the alignment point moves at a uniform speed along the predetermined trajectory. The laser emitter and the galvanometric mirror of the laser welding device are generally synchronously turned off, while in the embodiments of the present application, the galvanometric mirror is turned off after the laser emitter is turned off, which can be achieved by software control.

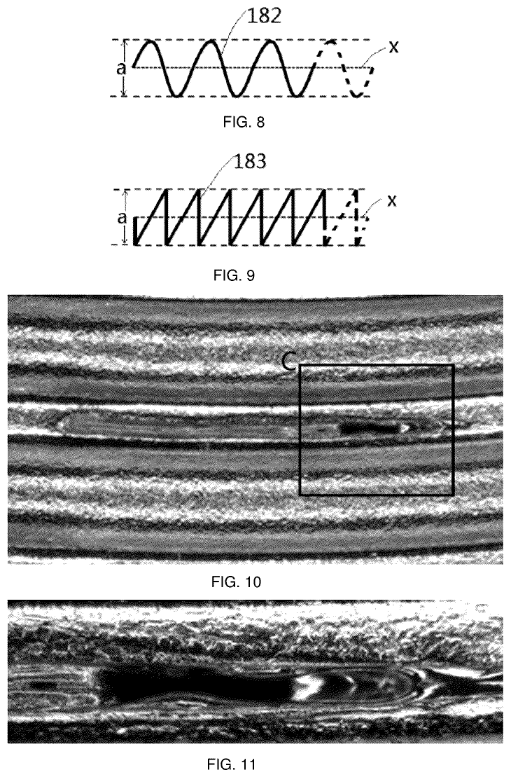

With further reference to FIGS. 7 to 9, in some embodiments, the predetermined trajectory is a straight line 181 parallel to the direction of the flow channel defined by the bipolar plate (FIG. 7), and alternatively, the predetermined trajectory may be a wave shape along the direction of the flow channel (taking the axis x parallel to the direction of the flow channel as the axis), wherein the wave shape may be a sine wave 182 (FIG. 8), a square wave, or a fold wave 183 (FIG. 9). The wave-shaped predetermined trajectory may increase the strength of the weld.

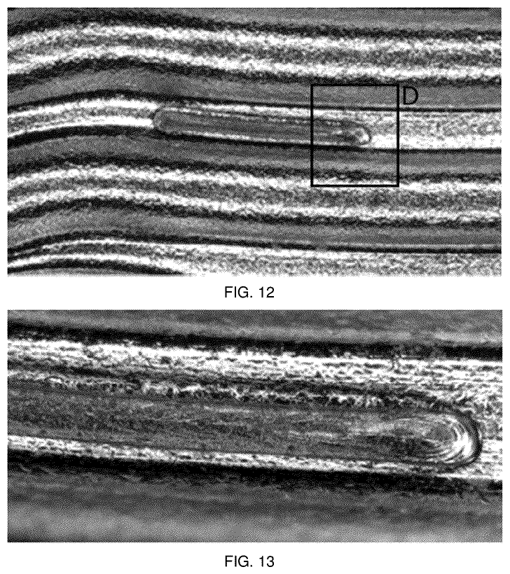

Continuing to refer to FIGS. 10 to 13, FIG. 10 is a picture of a weld when a laser emitter is turned off at the end point of a predetermined trajectory (the laser emitter and the galvanometric mirror are simultaneously turned off), and FIG. 11 is an enlarged view of area C of FIG. 10. It can be seen from FIGS. 10 and 11 that heat concentrations and perforations occur at the end point of the predetermined trajectory. FIG. 12 is a picture of a weld according to an embodiment of the present disclosure, and FIG. 13 is an enlarged view of area D of FIG. 12. It can be seen from FIGS. 12 and 13 that the weld depth is uniform and no heat concentrations or perforations are found at the weld end point.

According to other aspects of the present disclosure, a fuel cell is further provided, wherein a bipolar plate of the fuel cell is welded by the method according to embodiments of the present disclosure, and the resulting weld on the bipolar plate may have a uniform depth as shown in FIGS. 12 and 13. Further embodiments include a computer readable medium having a computer program recorded thereon, wherein, when the computer program is read and executed by a processor of the laser welding device, the processor causes the laser welding device to perform the method according to embodiments of the present disclosure. In some embodiments, the computer program causes the galvanometric mirror to continue movement for a predetermined time after the laser emitter is turned off.

The device and method according to the present disclosure can achieve a small deformation and good shape of the bipolar plate after welding, and the two bipolar plates are connected securely without perforations after welding, which avoids the leakage of the bipolar plate and improves the welding efficiency.

The specific embodiments described above in the present application are intended to only describe the principles of the present application more clearly, i.e. clearly illustrate or describe various components to make the principles of the present disclosure easier to understand. Within the scope of the present application, those skilled in the art can easily make various modifications or changes to the present application. Therefore, it should be understood that these modifications or changes are all included within the scope of the patent protection of the present application.

What is claimed is:

1. A laser welding method for a bipolar plate of a hydrogen fuel cell, comprising:
securing the bipolar plate in place and fitting an area to be welded of the bipolar plate;
determining a predetermined trajectory on the area to be welded for an alignment point of a laser welding device, the predetermined trajectory including a starting point and an end point;
moving the alignment point of the laser welding device along the predetermined trajectory from the starting point and activating a laser emitter of the laser welding device; and
turning off the laser emitter prior to the end point of the predetermined trajectory and maintaining movement of the alignment point along the predetermined trajectory until the end point of the predetermined trajectory is reached.

2. The laser welding method according to claim 1, wherein the laser emitter is turned off before a predetermined time or a predetermined distance from the alignment point to the end point of the predetermined trajectory.

3. The laser welding method according to claim 1, further comprising:
activating the laser emitter at a minimum power;
gradually increasing to a first power; and
maintaining the first power until turning off the laser emitter.

4. The laser welding method according to claim 1, further comprising:
moving the alignment point by movement of a galvanometric mirror of the laser welding device; and
after turning off the laser emitter, allowing the galvanometric mirror to continue to move.

5. The laser welding method according to claim 1, wherein:
the laser emitter is activated when the alignment point is at the starting point of the predetermined trajectory, or
the laser emitter is activated after a first delay time when the alignment point exits the starting point of the predetermined trajectory.

6. The laser welding method according to claim 1, wherein:
the predetermined trajectory is a straight line parallel to a direction of a flow channel defined by the bipolar plate; or
the predetermined trajectory is a wave shape along the direction of the flow channel.

7. The laser welding method according to claim 1, wherein the alignment point moves at a uniform speed along the predetermined trajectory.

8. The laser welding method according to claim 1, wherein:
the bipolar plate includes a sealing region at both ends and an activation region in the middle,
the bipolar plate each defines a plurality of parallel protrusions and grooves,
the area to be welded includes a groove located between adjacent protrusions in the activation region of the bipolar plate,
the bipolar plate has a thickness of less than 0.1 mm, and
the groove has a width of less than 0.5 mm.

9. A fuel cell, wherein a bipolar plate of the fuel cell is soldered through the method according to claim 1.

10. A computer readable medium having a computer program recorded thereon, wherein, when the computer program is read and executed by a processor of the laser welding device, the processor causes the laser welding device to perform the method according to claim 1.

11. The laser welding method according to claim 2, wherein the predetermined distance is greater than 1/10 of a total weld length, and the predetermined time is greater than 1/10 of a total weld time.

12. The laser welding method according to claim 2, wherein the predetermined time is greater than 0.5 ms, and the predetermined distance is greater than 0.5 mm.

13. The laser welding method according to claim 1, further comprising:
activating the laser emitter at the first power; and
maintaining the first power until turning off the laser emitter.

14. The laser welding method according to claim 6, wherein the wave shape is a sine wave, a square wave, or a fold wave.
